(19) United States
(12) Patent Application Publication
(10) Pub. No.: US 2011/0191141 A1
(43) Pub. Date: Aug. 4, 2011

(54) Method for Conducting Consumer Research

(76) Inventors: Michael L. Thompson, West Chester, OH (US); Diane D. Farris, West Chester, OH (US)

(21) Appl. No.: 12/700,069

(22) Filed: Feb. 4, 2010

(51) Int. Cl. G06Q 10/00; G06Q 30/00; G06F 17/30

(52) U.S. Cl. 705/7.32; 705/14.43; 707/736; 707/E17.014; 705/7.31

(57) ABSTRACT

A method for conducting consumer research includes steps of: designing efficient consumer studies to collect data suitable for reliable mathematical modeling of consumer behavior in a consumer product category. building reliable Bayesian (belief) network models (BBN) based upon direct consumer responses to the survey, upon unmeasured factor variables derived from the consumer survey responses, and upon expert knowledge about the product category and consumer behavior within the category. using the BBN to identify and quantify the primary drivers of key responses within the consumer survey responses (such as, but not limited to, rating, satisfaction, purchase intent. and using the BBN to identify and quantify the impact of changes to the product concept marketing message and/or product design on consumer behavior.

### FIELD OF THE INVENTION

The invention relates to computational methods for conducting consumer research. The invention relates particularly to computational methods for conducting consumer research by analyzing consumer survey data using Bayesian statistics.

### BACKGROUND OF THE INVENTION

Manufacturers, retailer and marketers of consumer products seek a better understanding of consumer motivations, behaviors and desires. Information may be collected from consumers via product and market surveys. Data from the surveys is analyzed to ascertain a better understanding of particular consumer motivations, desires and behaviors. Knowledge gained from the analysis may be used to construct a model of the consumer behavior associated with particular products or product categories. The complexity of the problem of modeling and predicting human behavior makes it possible to construct inaccurate models from the data which are of little value. A more robust method of conducting consumer research including analyzing consumer survey data that reduces the risk of an inaccurate model is desired.

### SUMMARY OF THE INVENTION

In one aspect, the method comprises steps of: preparing the data; importing the data into software; preparing for modeling; specifying factors manually or discovering factors automatically; creating factors; building a factor model; and interpreting the model.

In one aspect, the method comprises steps of: designing and executing an efficient consumer study to generate data, pre-cleaning the data; importing the data into Bayesian statistics software; discretizing the data; verifying the variables; treating missing values; manually assigning attribute variables to factors, or: discover the assignment of attribute variable to factors; defining key measures; building a model; identifying and revise factor definitions; creating the factor nodes; setting latent variable discovery factors; discovering states for the factor variables; validating latent variables; checking latent variable numeric interpretation; building a factor model; identifying factor relationships to add to the model based upon expert knowledge; identifying strongest drivers of a target factor node; and simulating consumer testing by evidence scenarios, or simulate population response by specifying mean values and probability distributions of variables.

In either aspect, the method may be used to modify or replace an existing model of consumer behavior.

The steps of the method may be embodied in electronically readable media as instructions for use with a computing system.

### BRIEF DESCRIPTION OF THE FIGURE

The FIGURE illustrates Consumer Study Purposes Mapped to the Space of Product and Consumer

### DETAILED DESCRIPTION OF THE INVENTION

This method of consumer research is applicable to consumer data—or more generally information containing data and domain knowledge—of a wide variety of forms from a wide variety of sources, including but not limited to, the following: Consumer responses to survey questions, consumer reviews, comments and complaints, done in any format including live-in-person, telephonic or video formats, paper or remote repsonse to a paper or computer screen delivered survey, all of which are possibly involving ratings, rankings, multiple choices, textual descriptions or graphical illustrations or displays (e.g., surveys, conjoint experiments, panel tests, diaries and stories, drawings, etc.) characterizing the consumers themselves (e.g., demographics, attitudes, etc.) and the consumer activities of browsing, selecting, choosing, purchasing, using/consuming, experiencing, describing, and disposing of products, packaging, utensils, appliances or objects relevant to understanding consumer behavior with the products of interest; Transactional data from real-world or virtual situations and markets and real-world or virtual experiments; Recording of video, audio and/or biometric or physiological sensor data or paralanguage observations and data, or post-event analysis data based on the previous recordings generated by consumer behavior gathered during consumer activities of browsing, selecting, choosing, purchasing, using/consuming, experiencing, describing, and disposing of products, packaging, utensils, appliances or objects relevant to understanding consumer behavior with the products of interest.

In all of these instances the data may be gathered in the context of an individual consumer or group of consumers or combinations of consumers and non-consumers (animate or inanimate; virtual or real). In all of these instances the data may be continuous or discrete numeric variables and/or may consist of any combination of numbers, symbols or alphabetical characters characterizing or representing any combination of textual passages, objects, concepts, events or mathematical functions (curves, surfaces, vectors, matrices or higher-order tensors or geometric polytopes in the space of the dimensions laid out by the numbers/symbols, each of which may have, but not necessarily have, the same number of elements in each dimension (i.e., ragged arrays are acceptable, as well as missing values and censored values as well). The method is also applicable to the results of mixing any combination of the above scenarios to form a more comprehensive, heterogeneous, multiple-study set of data or knowledge (i.e., data fusion).

Expert knowledge relating to a particular consumer product, market category, or market segment may be used to construct a theoretical model to explain and predict consumer behavior toward the product or within the segment or category. The method of the invention may be used to create an alternative to, or to augment, the expert knowledge based model and the results of the method may be used to modify or replace the expert based model.

The steps of the method are executed at least in part using a computing system and statistical software including Bayesian analysis. This type of software enables the data to be analyzed using Bayesian belief network modeling (BBN or Bayesian network modeling). BayesiaLab, available from Bayesia SA, Laval Cedex, France is an exemplary Bayesian statistics software program. In one aspect, the method comprises steps of: designing the consumer study; executing the consumer study to generate data, preparing the data; importing the data into software; preparing for modeling; specifying factors manually or discovering factors automatically; creating factors; building a factor model; interpreting the model; and applying the model for prediction, simulation and optimization. The method may be used to create or modify a model of consumer behaviors and preferences relating to a market category or particular products or services.

### Designing the Consumer Study:

The consumer study is designed based upon the purpose of the study and the modeling intended to be done after the data are collected. The method arrives at designs that are informationally efficient in the sense of providing maximum information about the relationships among the variables for a given number of products and consumers in the test.

The study and thus the data, which in general characterize consumer behavior with respect to products in a category, can therefore be thought to reside as a point in a space with two dimensions: (1) the product dimension and (2) the consumer dimension. The range of purposes for the studies therefore gives rise to a range of study designs in these two dimensions. Resource constraints (time, money, materials, logistics, etc.) will typically dictate the priorities that result in study purposes falling into the classes below.

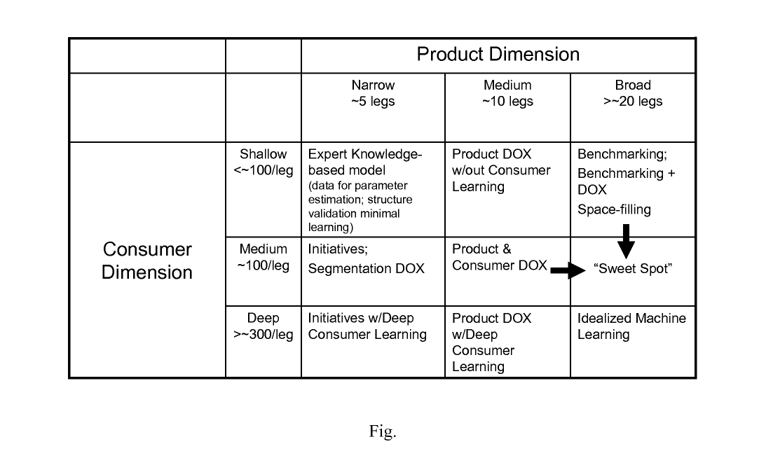

Study Purposes and Types: Typical study purposes include, but are not limited to, the following, which are mapped onto the product and consumer dimensions in FIG. 1:
1. Initiative Studies that focus on a few specific products in order to assess each and compare to others including learning in-depth knowledge about the heterogeneous consumer behavior within the context of each product. Narrow in the product dimension and deep in the consumer dimension.
2. DOX (Design Of eXperiments) are optimal experimental designs that seek to learn broad knowledge as unambiguously as possible about the impact of product attributes and/or consumer attributes on consumer behavior for product improvement. Medium to broad in the product dimension and shallow to deep in the consumer dimension.
3. Benchmarking Studies that seek to learn broad knowledge across the market representative products for assessment and comparison. Broad in the product dimension and medium to deep in the consumer dimension.
4. Benchmarking+DOX Studies that augment a Benchmarking study with a set of DOX-chosen products to get the best blend of market relevance and unambiguous learning of the impact of product/consumer attributes on consumer behavior. Broad in the product dimension and medium to deep in the consumer dimension.
5. Space-Filling Studies that blanket the product landscape to get broad coverage of the space and as deep as can be afforded in the consumer dimension. Deep in the product dimension and deep in the consumer dimension.

Implications of Study Purpose on Modeling and Inference: The purpose of the study has modeling and inference implications that fall into two broad classes:
1. Active—Causal Inference: In which the intent is to identify what impact specific manipulations of, or interventions upon, the basic product concept, design attributes, and/or performance aspects and the consumer demographics, habits, practices, attitudes and/or a priori segment identification will have upon the consumer responses and/or derived unmeasured factors based upon the responses and their joint probability distribution.
2. Passive—Observational Inference: In which the intent is to identify the relationships between the basic product concept, design attributes, and/or performance aspects and the consumer demographics, habits, practices, attitudes and/or a priori segment identification and the consumer responses and/or derived unmeasured factors based upon the responses and their joint probability distribution. Thus, in combination with category knowledge, implying what behavior would manifest itself in the consumer population upon manipulation of variables within the control of the enterprise placing the consumer test.

These two classes of purposes are not necessarily mutually exclusive and therefore hybrid studies combining an active investigation of some variables and a passive investigation of others can be served by the same study. Bayesian (belief) networks (BBN) are used for the identification and quantification of the joint probability distribution (JPD) of consumer responses to the survey questionnaire and/or latent variables derived from these responses and the resulting inference based upon the JPD.

Product Legs, Consumer Legs and Base Size: In defining the study, the two primary aspects of the design correspond to the product and consumer dimensions: (1) the type and number of product legs defining which products will be presented to and/or used by the consumers and (2) the type and number of consumers defining the base size (number of test respondents) and sampling strategy of the consumers.

Product Leg Specification: Product legs are chosen based upon the Active vs. Passive purpose with respect to subsets of the variables in question. This designation of subsets is best done in combination with the questionnaire design itself which defines the variables of the study and resulting dataset. For an Active study, product legs are chosen as a set of products placed in an orthogonal or near-orthogonal pattern in the space of the manipulatable variables using optimal experimental design (DOX) methods from statistics, which may also correspond to a broad “benchmarking” coverage of the market products directly or augmented with DOX-chosen legs explicitly with the manipulatable variables in mind. For a Passive study, product legs are chosen either as a few choice set of products of interest which do not explicit consider underlying manipulatable product variables or broad space-filling designs that do not obey DOX principles (e.g. orthogonality) on manipulatable variables.

Consumer Leg Specification: Consumer legs are driven based on the purpose of seeking deep knowledge in the consumer dimension and tailored according to the availability, suitability and feasibility of applying an a priori consumer segmentation to the consumer population.

Base Size Specification: Base size for the entire study is then built up by defining product legs and consumer legs, if any, and determining the base size per leg.

Base size per leg is specified using considerations from statistical power analysis and computational learning theory. Three main issues come into play: (1) How finely should the probability distributions be resolved, e.g., “What is the smallest difference in proportions between two groups of consumers responses to a question we should be able to resolve?” (2)

How complex are the relationships to be captured, e.g., “What is the largest number of free probability parameters that need to be estimated for each subset of variables represented in the BBN as parents (nodes with arcs going out) and child (node with arcs coming in)?” (3) How closely should the “true” data generation process be described, which in the limit of the entire category consumer population is the underlying consumer behavior and consumer survey testing behavior that gives rise to the consumer survey data, e.g., “What is the number of consumers needed to have a specified probability of success at estimating the theoretical limiting joint probability distribution of the consumer population responses to within a specified accuracy?”.

Rigorously, issue 1 informs the choices for issue 2 which in turn informs issue 3. This information has been captured in the form of heuristics to set the base size per design leg of the study.

First: Perform a power analysis on proportions, which is available in typical commercial statistical software such as JMP by SAS Institute, to determine how many samples—which in this case are consumer responses (i.e., base size)—are needed to estimate a difference a specified size (say 5%) in the proportions of two groups of samples assuming a specified average proportion (say 60%) of the two groups of samples. This value N(samples/proportion-test) will be the upper estimate of the number of samples per parameter in the BBN, but can be divided in half to get N(samples/params)=N(samples/proportion-test)/2, because not all proportions in the distribution are independent and need testing.

Second: Determine the number of free parameters that need to be estimated in the most complex relationship captured by the BBN, which is the number of independent probabilities N(params/leg) in the largest conditional probability table (CPT) of the BBN for each leg of interest and is calculated as N(params/leg)=PRODUCT(i=1, . . . , N(parents/child); N(states/parent_i))×(N(states/child)−1). Notice that this value assumes a certain complexity in the BBN model. If the final total base size seems excessive relative to the resource constraints, then

Third: Calculate number of samples per leg:

N(samples/leg)=N(samples/params)×N(params/leg)/2.

Fourth: Calculate total base size for the study N(base size)=N(samples/leg)×N(legs). Where N(legs) is the number of legs that are of primary interest (either product legs, consumer legs, or combined DOX legs). This resulting N(base size) will be an upper bound on the consumer study design base size.

A lower bound on the consumer study design base size can be found by assuming that not all parameters in the largest (or typical) CPT will be non-zero and thus be willing to ignore poor resolution of the joint probability distribution in the sparse data (tail) regions. A liberal lower bound would assume such a high linear correlation among parents having ordinal states (ordered numerical states) that the parents move in lock-step, and that the child is ordinal as well and moves in lock-step with the parents: In such a case, the CPT would only require N(params/leg)=Nstates(child).

Based upon the resource constraints of the study, choose what base size can be afforded within the range between the lower bound and upper bound values calculated as shown above. Notice that the calculation of N(params/leg) assumes a certain complexity in the BBN model. If the final total base size seems excessive relative to the resource constraints, it may be feasible to enforce discretization and aggregation of the variables during modeling to reduce N(states/parent_i) and N(states/child) and to limit N(parents/child) by reducing BBN complexity. Also settling for a larger deviation between the proportions in the power analysis would reduce the N(samples/proportion-test) and have a proportionate reduction on the total base size.

### Preparing the Data:

The data from which the model will be built may be prepared prior to importing it into the statistics software. Reliable modeling requires reliable information as input. This is especially true of the data in a machine learning context such as BBN structure learning that relies heavily upon the data. The data may be prepared by being pre-cleaned. Pre-cleaning alters or eliminates data to make the data set acceptable to the BBN software and to increase the accuracy of the final model.

Pre-cleaning may include clearly identifying the question that the model is intended to address and the variables needed to answer that particular question. Exemplary questions include benchmarking to predict product performance or trying to understand the relationship between product design choices and consumer response to the product.

Variables coded with multiple responses should be reduced to single response variables as possible. As an example, an employment status variable originally having responses including not employed, part-time and full-time may be recoded to simply employed making it a single response variable.

The responses for all variables may be recoded making each of them conform to a consistent 0-100 scale with all scales either ascending or descending.

The data should be screened for missing responses by subject and by question and for overly consistent responses. All responses for questions having more than about 20% of the total responses missing should be discarded. Similarly, all the responses from a particular subject having more than about 20% missing responses should be discarded. All responses from a subject who answered all the questions identically, (where the standard deviation of the answer set equals 0) should also be discarded.

Other missing responses should be coded with a number well outside the range of normal responses. As an example, missing responses with a scale of 0-100 may be coded with a value of 9999. For some questions, the value is missing as it makes no sense. For censored questions—the dependent question in a string of questions—the answer to a previous question may have mooted the need for a response to the dependent question. As an example, a primary question may have possible answers of yes/no. A secondary or dependent question may only have a reasonable answer when the primary answer is yes. For those surveys where the primary answer was no, the missing response may also be coded with a consistent answer well outside the typical range—e.g. 7777. Once the data has been pre-cleaned it may be imported into the BBN software suite.

### Importing the Data:

The data set or sets may be imported into a BBN software. Once the data has been imported, discretization of at least a portion of the variables may be advantageous. Discretization refers to reducing the number of possible values for a variable having a continuous range of values or just reducing the raw number of possible values. As examples, a variable having a range of values from 0 to 100 in steps of 1 may be reduced to a variable with 3 possible values with ranges 0-25, 25-75, and 75-100. Similarly a variable with 5 original values may be reduced to 2 or 3 values by aggregating either adjacent or non-adjacent but similar values. This discretization may provide a more accurate fit with small (N<1000) data sets and may reduce the risk of over-fitting a model due to noise in the data set.

### Preparing for Modeling:

After the data has been imported, a small but non-zero probability value may be assigned to each possible combination of variables. Bayesian estimation should be used rather than maximum likelihood estimation. This may improve the overall robustness of the developed model and the model diagnostics to prevent over-fitting of the model to the data.

The data should be reviewed to ensure that all variables were coded correctly. It is possible with incorrectly coded variables for the BBN to discover unreliable correlations. Variables could be incorrectly coded with an inverted scale or such that missing or censored values result in an incorrect number of value levels for the variable. A tree-structured BBN known as a Maximum Spanning Tree can be learned from the data in order to identify the strongest (high-correlation; high-mutual-information) relationships among the variables. Nodes not connected to the network should be investigated to ensure that the associated variables are coded correctly.

At this point, data cases with missing values can be imputed with the most probable values or with likely values by performing data imputation based upon the joint probability distribution represented by the Maximum Spanning Tree. This formal probabilistic imputation of missing values reduces the risk of changing (corrupting) the correlation structure among the variables by using simplified methods of treating missing values.

### Specifying Factors Manually or Discovering Factors Automatically:

Some variables like the target, typically purchase intent for consumer research, are of more interest than other ratings questions. These variables are typically excluded from the set of variables upon which unmeasured factors (i.e., latent variables) will be based. Nodes in the network corresponding to survey responses are considered to be manifestations of underlying latent factors and are called manifest nodes.

Latent variable discovery is performed by building a BBN to capture key correlations amongst attribute variables that will serve as the basis to define new factor variables. If this BBN is too complex, then even minor correlation amongst variables will be captured and the resulting factors will be few, each involving many attributes, and thus will be difficult to interpret. If this BBN is too simple, then only the very strongest correlation will be captured and the result will be more factors, each involving few or even single attributes, which leads to easy interpretation of factors but highly complex and difficult to interpret models based on these factors.

Without being bound by theory, it is believed that a BBN with about 10% of the nodes having 2 parents has been found to have suitable complexity for latent variable (factor) discovery. The complexity of the BBN as measured by the average number of parents per node (based on only those nodes connected in the network) should be near 1.1 for a suitable degree of confidence in capturing the strongest relationships among variables without missing possible important relationships. An iterative procedure of learning the BBN structure from data with a suitable BBN learning algorithm and then checking the average parent number should be done to arrive at a satisfactory level of complexity. If the average parent number is less than 1.05, the BBN should be re-learned using steps to make the network structure simpler. If the average parent number is more than 1.15, the BBN should be re-learned using steps to make the network structure more complex.

After the BBN with average parent number of about 1.1 is found (as described above), latent variable discovery proceeds determining which attributes are assigned to the definition of which factors. An iterative automatic factor assignment procedure is used to assign BBN variables to factors. The procedure constructs a classification dendrogram, which is a, possibly asymmetric, graphical tree with nodes (variables) as leaves and knots splitting branches into two labeled with the KLD between the joint probability distribution (JPD) of the variables represented by the leaves of the two branches and the estimate of the joint probability of the variables using the product of the two joint probability distributions of the variables in each of the two branches. A suitable criterion for the KLD or a p-value based on a chi-square test statistic derived from the KLD is used to identify the greatest discrepancy between a JPD and its estimate by the pair of branch JPDs that can be tolerated within a single factor. In this way, the dendogram defines the partition of the variables in the BBN into sets corresponding to the factors to which the sets will be assigned.

This automatic factor assignment procedure may result in some factor definitions that do not best fit the modeling intentions, mainly due to ambiguous or confusing interpretations of the factors. Applying category knowledge to vet these automatically discovered factors and subsequently edit the factor assignments may improve this situation.

### Creating Factors:

After identifying which attributes participate in each factor, latent variable discovery proceeds with the creation of the latent variables themselves. An iterative automated factor creation procedure takes each set of variables identified in the factor assignment step above and performs cluster analysis among the dataset cases to identify a suitable number of states (levels) for the newly defined discrete factor. This algorithm has a set of important parameters that can dramatically change the reliability and usefulness of the results. Settings are used that improve the reliability of the resultant models (tend to not overfit while maintaining reasonable complexity); that allow numerical inferences about the influence of each attributes on the target variables; and allow numerical means to be used in Virtual Consumer Testing.

With consumer survey data, which have base sizes N˜1000 or less, fewer “clusters” per factor may be desirable. Also, subsequent analysis may require numeric factors so use factors with “ordered numerical states”.

The factor creation procedure uses clustering algorithms capable of searching the space of number of clusters and using a subset of the dataset to decide up the best number of clusters. This space is limited to be 2 to 4 clusters and the entire dataset is typically used for datasets on the order of 3000 cases or less; otherwise a subset of about that size is used.

Several measures can be computed to describe how well each factor summarizes the information in the attributes that define it and how well the factor discriminates amongst the states of the attributes. Purity and relative significance are heuristics that provide minimum threshold values that the measures in the Multiple Clustering report must exceed in order for each factor to be considered reliable. Contingency Table Fit (CTF, which is the percentage in which the mean negative log-likelihood of the model on the relevant dataset lies between 0 corresponding to the independence model (a completely unconnected network) and 100 corresponding to the actual data contingency table (a completely connected network)).

If attribute variables that define the same factor are negatively correlated or not linearly related to each other, then the numerical values associated to the states of the newly created factor will not be reliable. They may not be monotonically increasing with the increasingly positive response of the consumer to the product or they may not have any numerical interpretation at all (in the general case in which some of the attributes are not ordinal. It is important to validate the state values of each factor.

The state values of each factor can be validated by several means: For example, given a factor built from five “manifest” (attribute) variables, you can do either of the following: (1) Generate the five 2-way contingency tables between each attribute and the factor and confirm that the diagonal elements corresponding to low-attribute & low-factor to high-attribute & high-factor states have larger values than the off-diagonal elements. (2) Use a mosaic analysis (mosaic display) of the five 2-way mosaic plots and doing the same as for #1. (3) Plot the five sets of histograms or conditional probability plots corresponding to each attribute's probability distribution given the assignment of the factor to each of its state's values in order from low to high and confirm that the mode of the attribute's distribution moves (monotonically) from its lowest state value to its highest state value.

Mosaic analysis (Mosaic display) is a formal, graphical statistical method of visualizing the relationships between discrete (categorical) variables—i.e., contingency tables—and reporting statistics about the hypotheses of independence and conditional independence of those relationships. The method is described in “Mosaic displays for n-way contingency tables”, Journal of the American Statistical Association, 1994, 89, 190-200 and in “Mosaic displays for log-linear models”, American Statistical Association, Proceedings of the Statistical Graphics Section, 1992, 61-68.

Also, a useful check is whether the minimum state value and maximum state value of the factor have a range that is a significant proportion (>˜50%) of the minimum and maximum values of the attributes. If it does not, then the factor may have state values too closely clustered about the mean values of the attributes and may signal that some of the attributes are negatively correlated with each other. In such a case, the attributes values should be re-coded (i.e., reversing the scale) so that the correlation is positive OR the factor states should be re-computed manually by re-coding the attribute value when averaging its values into the factor state value.

### Building a Factor Model:

Given reliable numerical factor variables, a BBN is built to relate these factors to the target variable and other key measures. To identify relationships that may have been missed in this BBN and that can be remedied by adding arcs to the BBN, check the correlation between variables and the target node as estimated by the model against the same correlations computed directly from data. If a variable is only weakly correlated with the target in the BBN but strongly correlated in the data, use category knowledge and conditional independence hypothesis testing to decide whether or not to add an arc and if so, where to add an arc to remedy the situation.

The Kullback-Leibler divergence (KLD) between the model with the arc versus that without the arc may be analyzed. Also, each arc connecting a pair of nodes in the network can be assessed for its validity with respect to the data by comparing the mutual information between the pair of nodes based on the model to the mutual information between that pair of variables based directly upon the data.

The model strength of target node correlation with all variables may be compared to actual data correlations using the Analysis-Report-Target Analysis-Correlation wrt Target Node report.

Expert knowledge of the relationships between variables may be incorporated into the BBN. The BBN can accommodate a range of expert knowledge from nonexistent to complete expert knowledge. Partial category and/or expert knowledge may be used to specify relationships to the extent they are known and the remaining relationships may be learned from the data.

Category or expert knowledge may be used to specify required connecting arcs in the network, to forbid particular connecting arcs, causal ordering of the variables, and pre-weighing a structure learned from prior data or specified directly from category knowledge.

Arcs between manifest nodes or key measures or arcs designating manifest Nodes as parents of factors may be forbidden to enhance the network. Variables may be ordered from functional attributes that directly characterize the consumer product, to higher order benefits derived from the functional attributes, to emotional concepts based upon the benefits, to higher order summaries of overall performance and suitability of the product, to purchase intent.

Statistical hypothesis testing may be used to confirm or refute the ordering of variables and the specification or forbidding of arcs.

Over fitting is one of the risks associated with nonparametric modeling like learning BBN structure from data. However, under fitting, in which the model is biased or systematically lacks fit to the data, is another risk to avoid. In BBN learned from score optimization, such as in BayesiaLab, the score improves with goodness of fit but penalizes complexity so as to avoid not learning noise. The complexity penalty in BayesiaLab is managed by a parameter known as the structural complexity influence (SCI) parameter.

When sufficient data exist (N>1000), using the negative-log-likelihood distributions from a learning dataset and a held-out testing dataset enables finding the range of SCI that avoids both over fitting and under fitting. When less data are available (N<1000), it is often more reliable to use cross-validation and look at the arc confidence metrics.

For smaller datasets (N<1000), iteratively use the Tools-Cross-Validation-Arc Confidence feature with K=20 to 30 and increase the SCI until the variability among the resulting BBN structures is acceptably low.

A strength of BBN is its ability to capture global relationships amongst thousands of variables based upon many local relationships amongst a few variables learned from data or specified from knowledge. Incorporating more formal statistical hypothesis testing can reduce the risk of adopting a model that may not be adequate. The G-test statistic may be used to evaluate the relationships between variables.

A BBN is able to reduce global relationships to many local relationships in an efficient manner is that the network structure encodes conditional independence relationships (whether learned from data or specified from knowledge). Validating that these are indeed consistent with data has not been possible in BBN software. Although some software explicitly incorporate conditional independence testing in learning the BBN structure from data, BayesiaLab doesn't and no other software allows the user to test arbitrary conditional independencies in an interactive manner. This is especially useful when trying to decide when to add, re-orient or remove a relationship to better conform to category (causal) knowledge. Mosaic Analysis may be used to test conditional independence relationships.

### Interpreting the Model:

When doing drivers analysis in structural equations models (SEM) a number of inferential analyses such as “Top Drivers” and “Opportunity Plots” are based upon the “total effects” computed from the model. In SEM these total effects have a causal interpretation—but limited to linear, continuous-variate, model assumptions.

In BBN, such a quantity has only been defined for a causal BBN but has not been defined for a BBN built from observational data and not interpreted as a causal model. For an (observational) BBN (rather than causal BBN), the analog to the total effects are observational “total effects”, which are more appropriately called “sensitivities”.

The “total effect” of a numeric target variable with respect to another numeric variable is the change in the mean value of the target variable if the mean of the other variable were changed by 1 unit. Standardized versions of these simply multiply that change by the ratio of the standard deviations of the other variable over that of the target variable. It happens that the “standardized total effect” equals the Pearson's correlation coefficient between the target variable and the other variable. Using partial causal knowledge, inferences based on these BBN sensitivities may be drawn with respect to Top Drivers and Opportunity Plots involving the most actionable factors.

The standardized values are used to rank-order top drivers of the target node and to build “Opportunity Plots” showing the mean values of the variables for each product in the test vs. the standardized sensitivity of the variables.

BBN perform simulation (What-if? scenario analysis) by allowing an analyst to specify “evidence” on a set of variables describing the scenario and then computing the conditional probability distributions of all the other variables. Traditionally, BBN only accept “hard” evidence, meaning setting a variable to a single value, or “soft” evidence, meaning specifying the probability distribution of a variable. The latter is more appropriate to virtual consumer testing. Fixing the probability distribution of the evidence variables independently or specifying the mean values of the evidence variables and have their likelihoods computed based on the minimum cross-entropy (minxent) probability distribution is more consistent with the state of knowledge a consumer researcher has about the target population he/she wishes to simulate.

Target sensitivity analysis can be performed to assist in the visualization of the influence of specific drivers on particular targets. Calculating the minxent probability distribution based upon the mean value for a variable enables the creation of plots of the relationship of the mean value of a target node of the BBN as the mean values of one or more variables each vary across a respective range. These plots allow the analyst to visualize the relative strengths of particular variables as drivers of the target node.

Although the BBN structure clearly displays relationships among variables, a BBN does not explicitly report why it arrived at the inferences (conditional probabilities) under the assertion of evidence scenarios that it does. Evidence Interpretation Charts provide an efficient way of communicating the interpretation of the BBN inferences. Evidence Interpretation Charts graphically illustrate the relationship between each piece of evidence asserted in a given evidence scenario and simultaneously two other things: (1) one or more hypotheses about the state or mean value of a target variable and (2) the other pieces of evidence, if any, asserted in the same evidence scenario or alternative evidence scenarios.

The charts enable the identification of critical pieces of evidence in a specific scenario with respect to the probability of a hypothesis after application of the evidence of the scenario and the charts provide an indication of how consistent each piece of evidence is in relation to the overall body of evidence.

The title of the evidence interpretation chart reports the hypothesis in question and gives four metrics: 1. The prior probability of the hypothesis before evidence was asserted, P(H). 2. The posterior probability of the hypothesis given the asserted evidence E, P(H|E). 3. The evidence Bayes factor of this hypothesis and evidence, BF=log 2(P(H|E)/P(H)). 4. The global consistency measure of this hypothesis and evidence, GC=log 2(P(H,E)/(P(H)PiP(Xi))), where PiP(Xi) denotes the series product of the prior probabilities of each piece of evidence Xi. BF and GC have units of bits and can be interpreted similarly to model Bayes factors.

The EIC method is applicable to hypotheses that are compound involving more than a simple single assertion. This makes computation of P(H|E) at first seem difficult but in fact using the definition of conditional probability it can be computed readily from the joint probabilities P(H,E) and P(E). For example, consider a scenario in forensic evidence in law. Suppose the pieces of evidence are different aspects of the testimonies of two witnesses about what and when they saw and heard at the scene of a crime: E={witness1-saw=J.Doe, witness2-time=morning, witness2-heard=gunshots, witness2-wokeup=morning}. And the hypothesis could be a compound set of assertions such as H={time-ofcrime=morning, perpetrator=J.Doe, motive=money}. The conditional probability P(H|E) can be computed using the definitional equation P(H|E)=P(H,E)/P(E).

The EIC method is useful in contrasting the support or refutation of multiple hypotheses H1, H2, . . . , Hn under the same scenario of asserted evidence E. An overlay plot of the pieces of evidence given each hypothesis can be shown on the same EIC. In this case of the same evidence E, the x coordinates of each piece of evidence will be the same regardless of hypothesis but the y-coordinate will show which pieces support one hypothesis while refuting another and vice versa. From this information we can identify the critical pieces of evidence that have significantly different impact upon the different hypotheses. Also, the title label may indicate from the posterior probabilities the rank-ordering of the hypotheses from most probable to least and from the BF and GC which hypotheses had the greatest change in the level of truth or falsity and the greatest consistency or inconsistency with the evidence, respectively.

The method is useful in contrasting multiple evidence scenarios E1, E2, . . . , En and the degree to which they support or refute the same hypothesis H. An overlay plot of the pieces of evidence given each scenario can be shown on the same EIC. In this way we can easily identify which evidence scenario most strongly supports or refutes the hypothesis and which are most consistent or inconsistent.

An overlay of the evidence hypothesis scenarios on the same EIC can lead to easy identification of what are the critical pieces of evidence in each scenario.

The EIC method is also applicable to “soft” evidence, in which the pieces of evidence are not the assertion of a specific state with certainty, which is called “hard” evidence, but rather is the assertion of either (1) a likelihood on the states of a variable, (2) a fixed probability distribution on the states of a variable, or (3) a mean value and minimum cross-entropy (MinXEnt) distribution on a variable if the variable is continuous. So EIC applies to any mix of hard and/or soft evidence. When a node Xi has soft evidence, then the x(Xi) and y(Xi) coordinate values of the piece of evidence are computed as the expected values of the definitions above over the posterior distribution P(Xi|E\Xi, H)=P(Xi,E\Xi, H)/P(E\Xi, H): The consistency of the evidence Xi with the remaining evidence E\Xi is defined as x(Xi)=SjP(Xi=xj|E\Xi, H) log 2(P(Xi=xj|E\Xi)/P(Xi=xj)). The impact of the evidence Xi on the hypothesis H in the context of evidence E is defined as y(Xi)=SjP(Xi=xj|E\Xi, H) log 2(P(H|E\Xi, Xi=xj)/P(H|E\Xi)), where E\Xi is the set of evidence excluding the piece of evidence Xi.

In the case of soft evidence, we also know which states xj of the set of non-zero-probability states of the variable Xi tended to support or refute the hypothesis and tended to be consistent or inconsistent with the remaining evidence by looking at the logarithmic term for each xj. Therefore we can indicate this information in the plot by labeling each point with a color-coded label of the states within the piece of evidence, where green indicates support and red indicates refutation of the hypothesis.

The EIC method can be used as a mean-variance inference variant for continuous variables Y and

Xi, where the hypothesis is H=mean(Y)=y and the evidence is E={mean(Xi)=ix}. This is done by substituting the differences between the mean values for the log-ratios of the metrics BF, x(Xi) and y(Xi). (Note a log-ratio is a difference in logarithms. For the continuous-variate mean-variance inferences we use a difference in mean instead of log.) a. Replace BF with the overall impact of the evidence on the hypothesis D y=mean(Y|E)−mean(H). b. The consistency of the evidence Xi with the remaining evidence E\Xi is replace by

x(Xi)=mean(Xi|E\Xi)−mean(Xi), which is the change in mean of Xi given E\Xi from its prior mean. c. The impact of the evidence Xi on the hypothesis H in the context of evidence E is defined as y(Xi)=mean(Y|E)−mean(Y|E\Xi), which is the change in mean of Y given all evidence from it mean given the evidence without that asserted for variable Xi. d. To account for the different variances of the variables, we may choose to display the pieces of evidence in their standardized units, which are the x and y coordinates given above divided by the standard deviation of the variable as computed from its posterior distribution.

The EIC method is also has a sequential variant applicable to situations in which the order in which the evidence is asserted is important to the interpretation of the resulting inferences. Examples of this are when evidence is elicited during a query process like that of the “Adaptive Questionnaire” feature in BayesiaLab by Bayesia or as a most-efficient assertion sequence like that returned by the “Target Dynamic Profile” feature in Bayesialab. In this case, the conditioning set of evidence in each of the definitions of all of the metrics above has E replaced with E<=Xi and has E\Xi replaced with E<Xi; where E<=Xi means all evidence asserted prior to and including the assertion of Xi, and E<Xi means all evidence asserted prior to the assertion of Xi. In such an EIC, the labels on the points for the pieces of evidence would include a prefix indicating the order in which that piece of evidence was asserted: e.g., 1.preferred-color=white if preferred-color was the first variable asserted.

The following describes the construction of an Evidence Interpretation Chart. The hypothesis node Y may be referred to as “the target node”.

First, sort evidence by log-ratio of each assertion Xi=xi with hypothesis assertion Y=y. If it is hard evidence, compute this as I(Y, Xi|E\{Xi,Y})=log 2(P(Xi=xi|E\{Xi})/P(Xi=xi|E\{Xi,Y})); where Y denotes evidence assertion Y=y; E\{X} denotes the evidence set E excluding assertion X=x; and E\{X,Y} denotes the evidence set E excluding assertion X=x and Y=y. If it is soft evidence compute this by taking the expected value of the log term above with respect to each hard assertion Xi=xij, averaged over the posterior P(Xi|E\{Xi,Y}), where xij is a member of the set of states of Xi that have non-zero probability in the posterior distribution P(Xi|E\{Xi,Y}). Note which log terms are positive and negative to dictate the color-coding of the states in the label for the point, where green is used for positive and red for negative.

Next, compute consistency of evidence Xi=xi with all other evidence E\{Xi,Y}. If it is hard evidence, compute this as C(Xi|E\{Xi,Y}))=log 2(P(Xi=xi|E\{Xi,Y})/P(Xi=xi)); and include these values of C(Xi|E\{Xi,Y}))) in the sorted table. If it is soft evidence compute this by taking the expected value of the log term above with respect to each hard assertion Xi=xij averaged over the posterior P(Xi|E\{Xi,Y}), where xij is a member of the set of states of Xi that have non-zero probability in the posterior distribution P(Xi|E\{Xi,Y}).

Lastly, create the Evidence Interpretation Chart by overlay plotting for each Xi a point having I(Y,Xi|E\{Xi}) as y-coordinate vs. C(Xi|E\{Xi,Y}) as x-coordinate for each assertion of TargeY=y.

BBN learned from observational data—which are not experimentally designed data with respect to formal experiments performed to identify causal relationships by conditional independence testing—are not causal models and do not provide causal inferences. Causality is important to be able to reliably intervene on a variable and cause a change in the target variable in the real world. Decision policy relies on some level of causal interpretation being validly assigned to the model inferences.

The BBN built in BayesiaLab for Drivers Analysis are observational models that capture observed distributions of variables and their relationships but these relationships may not coincide with causal relationships. In other words, the directions of the arrows in the BBN do not necessarily imply causality. Furthermore, the inferences performed in BBN software are observational, in that evidence may be asserted on an effect and the resulting state of the cause may be evaluated using reason—i.e., reason backwards with respect to causality. This is one of the powerful aspects of BBN: information flows in all directions within the network rather than solely in the direction of the arrows. To confidently drive actions in the real world based on predictions from a BBN, there must be some level of confidence that the variables acted upon will cause a change in the target variable as an effect. There must be at least a partial sense of causality in the inferences derived from Drivers Analysis on BBN.

To maximize the usefulness of these inferences a greater level of causality may be assigned to the BBN, making it a causal BBN, and causal inference may be performed according to the theory derived by Prof. Judea Pearl of UCLA and professors at Carnegie Mellon Univ.

By asserting fixed probability distribution and performing target sensitivity analysis, it is possible to quantitatively attribute the differences in the purchase intent of each product, in a head-to-head product comparison, to the specific quantitative differences in the factor and key measures of each product.

Given a causal BBN, causal inferences such as what differences in the consumer responses to two different products most strongly determines the differences in the consumers' purchase intents for those two products may be made. This type of “head-to-head” comparison enables a better understand of why one of two products is winning/losing in a category and how best to respond with product innovations.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for conducting consumer research, the method comprising steps of:
a) designing efficient consumer studies to collect consumer survey responses suitable for reliable mathematical modeling of consumer behavior in a consumer product category;
b) building reliable Bayesian (belief) network models (BBN) based upon direct consumer responses to the survey, upon unmeasured factor variables derived from the consumer survey responses, and upon expert knowledge about the product category and consumer behavior within the category;
c) using the BBN to identify and quantify the primary drivers of key responses within the consumer survey responses (such as, but not limited to, rating, satisfaction, purchase intent; and
d) using the BBN to identify and quantify the impact of changes to the product concept marketing message and/or product design on consumer behavior.

2. A method for conducting consumer research, the method comprising steps of:
a) designing efficient consumer studies to collect consumer survey responses suitable for reliable mathematical modeling, computer simulation and computer optimization of consumer behavior in a consumer product category;
b) building reliable Bayesian (belief) network models (BBN) based upon direct consumer responses to the survey, upon unmeasured factor variables derived from the consumer survey responses, and upon expert knowledge about the product category and consumer behavior within the category;
c) using the BBN to identify and quantify the primary drivers of key responses within the consumer survey responses (such as, but not limited to, rating, satisfaction, purchase intent;
d) using the BBN to identify and quantify the impact of changes to the product concept marketing message and/or product design on consumer behavior;
e) using the BBN to predict the consumer responses of a population of consumers in a product category and infer consumer behavior in response to hypothetical product changes in the context of consumer demographics, habits, practices and attitudes;
f) using the BBN to predict consumer responses and infer their behavior to hypothetical product changes in the context of specific consumer demographics, habits, practices and attitudes;
g) using the BBN to select product-consumer attribute combinations that help maximize predicted consumer responses to hypothetical product changes in the context of specific consumer demographics, habits, practices and attitudes; and
h) optimizing product concept message, product design and target consumer based on optimal product-consumer attribute combinations.

3. A method for conducting consumer research, the method comprising steps of:
a) preparing the data;
b) importing the data into software;
c) preparing for modeling;
d) specifying factors manually or discovering factors automatically;
e) creating factors;
f) building a factor model; and
g) interpreting the model.

4. A method for conducting consumer research, the method comprising steps of:
a) pre-cleaning the data;
b) importing the data into Bayesian analysis software;
c) verifying the variables;
d) treating missing values;
e) manually assigning attribute variables to factors, or: discover the assignment of attribute variable to factors;
f) defining key measures;
g) building a model;
h) identifying and revising factor definitions;
i) creating the factor nodes;
j) setting latent variable discovery factors;
k) discovering states for the factor variables;
l) validating latent variables;
m) checking latent variable numeric interpretation;
n) building a factor model;
o) identifying factor relationships to add to the model based upon expert knowledge;
p) identifying strongest drivers of a target factor node; and
q) simulating consumer testing by evidence scenarios, or simulate population response by specifying mean values and probability distributions of variables.

5. The method according to claim 4 comprising the further step of assigning a non-zero probability to zero probability value sets.

6. The method according to claim 4 comprising the further steps of learning an initial BBN and investigating nodes which are not connected to the network.

7. The method according to claim 4 comprising the further step of forbidding arcs connecting manifest nodes with each other or with key measures.

8. The method according to claim 4 comprising the further step of setting a complexity penalty value for the BBN.

9. The method according to claim 4 comprising the further step of performing mosaic analysis.

10. The method according to claim 4 comprising the further step of performing target sensitivity analysis.

11. The method according to claim 4 comprising the further step of constructing evidence interpretation charts.

12. The method according to claim 4 comprising the further step of conducting a head to head comparison using target sensitivity analyses.
